(19) United States
(12) Patent Application Publication
(10) Pub. No.: US 2015/0172774 A1
(43) Pub. Date: Jun. 18, 2015

(54) ELECTRONIC APPARATUS AND DISPLAY CONTROL METHOD

(71) Applicant: KABUSHIKI KAISHA TOSHIBA, Tokyo (JP)

(72) Inventors: Kenichi Taniuchi, Yokohama Kanagawa (JP); Kazuhiko Kashiwagi, Tokorozawa Saitama (JP); Akira Kumagai, Ome Tokyo (JP); Yuuichiro Aso, Hamura Tokyo (JP)

(21) Appl. No.: 14/510,419

(22) Filed: Oct. 9, 2014

(30) Foreign Application Priority Data
Dec. 13, 2013 (JP) 2013-258310

(51) Int. Cl. H04N 21/478; H04N 21/422; H04N 21/254; H04N 21/431; H04N 5/445; H04N 21/41; H04N 21/4782

(52) U.S. Cl. CPC H04N 21/47815; H04N 21/4126; H04N 21/4222; H04N 21/4782; H04N 21/4312; H04N 5/44513; H04N 21/2542

(57) ABSTRACT

According to one embodiment, an electronic apparatus includes a receiver, processing circuitry, and a transmitter. The receiver receives first data and second data from a server, the first data being for displaying an image of a first item, the second data being for displaying a graphical user interface relating to the first item. The processing circuitry displays the graphical user interface on a screen by using the second data. The processing circuitry generates first video data for displaying the image on an external display by using the first data. The transmitter transmits the first video data to the external display.

### CROSS-REFERENCE TO RELATED APPLICATIONS

This application is based upon and claims the benefit of priority from Japanese Patent Application No. 2013-258310, filed Dec. 13, 2013, the entire contents of which are incorporated herein by reference.

### FIELD

Embodiments described herein relate generally to an electronic apparatus of controlling the display of content and a display control method applied to the apparatus.

### BACKGROUND

When buying an item online, a user decides whether to buy an item on sale by referring to pictures and a movie of the item displayed on a screen of a client device such as a notebook-type personal computer (PC), tablet computer, smartphone, etc. The client device receives web content including, for example, images and descriptive text of an item on sale from a server of an online store and displays the web content on the screen.

Here, the web content may contain graphical user interface (GUI) elements such as menus and buttons in addition to the images and descriptive text. From the server, the client device such as a smartphone and tablet computer receives web content including not only the images and descriptive text of an item on sale but also the menus and buttons used for buying the item.

When such web content is displayed on a small screen of a smartphone or a tablet computer, a user may perform an operation for enlarging a part of the web content or an operation for scrolling the web content, and such operations are often troublesome.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view for explaining an example of an online shopping system using an electronic apparatus (tablet computer) according to an embodiment.

FIG. 2 is a block diagram showing an example of a system configuration of the electronic apparatus of the embodiment.

FIG. 3 is a block diagram showing an example of a functional configuration of a browser application program executed by the electronic apparatus of the embodiment.

FIG. 4 is a view showing an example of an image of an item displayed on a television receiver using video data generated by the electronic apparatus of the embodiment.

FIG. 5 is a view showing an example of graphical user interface (GUI) elements relating to the item shown in FIG. 4 displayed by the electronic apparatus of the embodiment.

FIG. 6 is a view showing an example of the image of the item displayed on the television receiver using the video data generated in accordance with an operation on the GUI elements shown in FIG. 5.

FIG. 7 is a view showing an example of an image of another item displayed on the television receiver using the video data generated in accordance with an operation on the GUI elements shown in FIG. 5.

FIG. 8 is a view showing an example of the GUI elements relating to the item of FIG. 7 displayed by the electronic apparatus of the embodiment.

FIG. 9 is a view showing an example of an image of an item and GUI elements relating to the item displayed by the electronic apparatus of the embodiment.

FIG. 10 is an exemplary view showing an image of an item and handwritten information displayed on the television receiver using the video data generated by the electronic apparatus of the embodiment.

FIG. 11 is a flowchart showing an example of the procedure of a display control process executed by the electronic apparatus of the embodiment.

FIG. 12 is a flowchart showing another example of the procedure of a display control process executed by the electronic apparatus of the embodiment.

FIG. 13 is a flowchart showing an example of the procedure of an operation process executed by the electronic apparatus of the embodiment.

### DETAILED DESCRIPTION

Various embodiments will be described hereinafter with reference to the accompanying drawings.

In general, according to one embodiment, an electronic apparatus includes a receiver, processing circuitry, and a transmitter. The receiver receives first data and second data from a server, the first data being for displaying an image of a first item, the second data being for displaying a graphical user interface relating to the first item. The processing circuitry displays the graphical user interface on a screen by using the second data. The processing circuitry generates first video data for displaying the image on an external display by using the first data. The transmitter transmits the first video data to the external display.

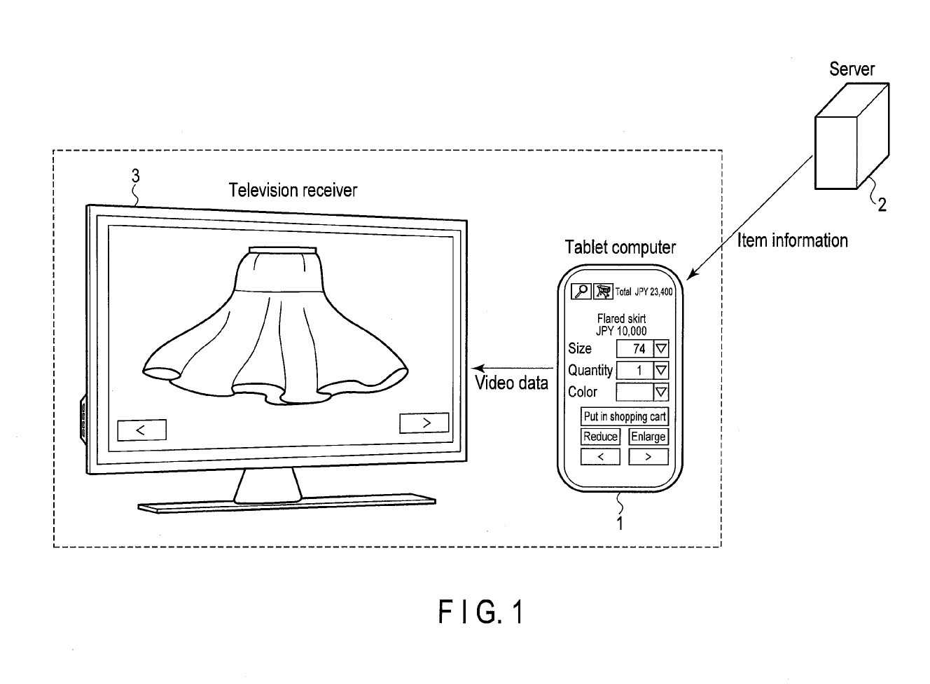

FIG. 1 shows an example of online shopping system using an electronic apparatus according to one embodiment. The electronic apparatus is, for example, a stylus-based portable electronic apparatus which can execute a handwriting input with a stylus or a finger. The electronic apparatus may be realized as a tablet computer, notebook-type personal computer, smartphone, PDA, etc. In the description below, the case is assumed that this electronic apparatus is realized as a tablet computer 1. The tablet computer 1 is a portable electronic apparatus which is also called as “tablet” or “slate computer”.

The tablet computer 1 executes, based on a user's operation thereon, such processes as receiving information of merchandise provided for online shopping from a server 2 and ordering an item the user wishes to buy. The tablet computer 1 receives the information of merchandise from the server 2 and controls display of the information of merchandise.

The tablet computer 1 displays the information of merchandise on the screen of the tablet computer 1. The user refers to images and descriptive text of merchandise displayed on the screen of the tablet computer 1, and if the user wishes to buy an item, he/she designates size, quantity, color, and other details relating to the item and operates a GUI element (such as button) to buy the item. Through such a process, the user can order the item online.

Here, as mentioned above, the tablet computer 1 is a portable electronic apparatus and thus, the entire information of the item may not be shown within an initially displayed area of its screen and details of the item image may not be fully understood due to its small size (low resolution). In that case, since the user must perform a scroll operation for displaying information which is not shown in the initially displayed area and an enlargement operation for enlarging the image, the number of operations by the user increases and operation complexity may increase accordingly.

Therefore, in the present embodiment, a television receiver (TV) 3 which receives/transmits data from/to the tablet computer 1 displays the image of item and the tablet computer 1 displays the GUI elements for operations relating to the item on the screen thereof. Since the image of the item is not displayed on the screen of the tablet computer 1, the area used for displaying the image of the item can be diverted for displaying the GUI elements. Thus, for example, buttons and input areas can be enlarged and the displayable number of buttons and input areas can be increased. Therefore, the user can refer to the image of the item on a large screen of the television receiver 3 and easily operate the GUI elements such as buttons and menus on the screen of the tablet computer 1.

Note that the television receiver 3 by which the image of item is displayed may be any external display device whose screen size is larger than that of the tablet computer 1 (portable electronic apparatus) and namely, may be a notebook-type computer and the like.

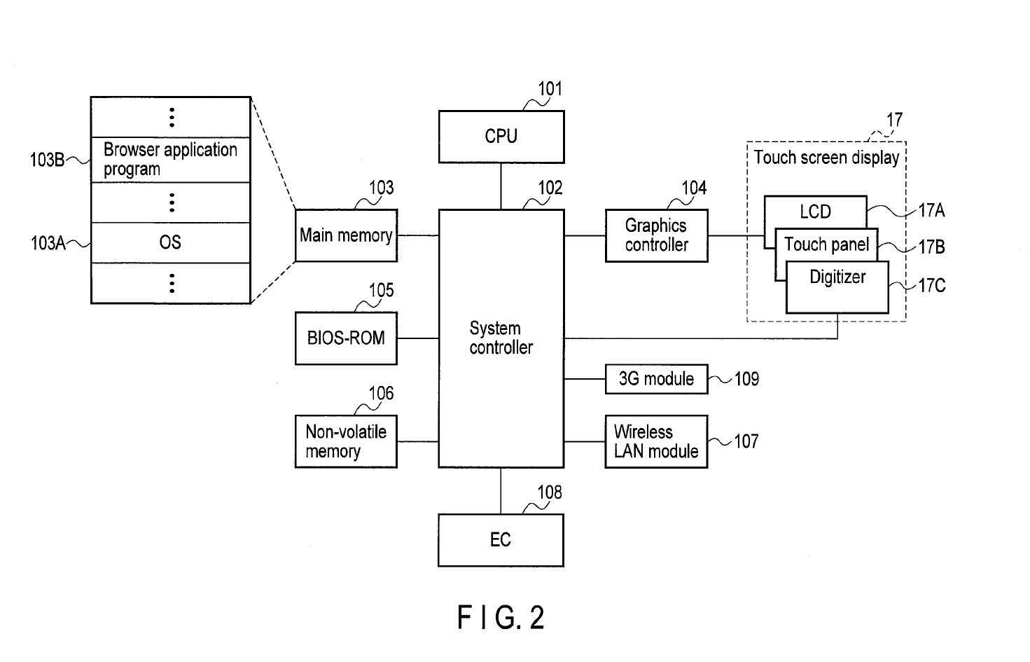

FIG. 2 shows a system configuration of the tablet computer 1.

The tablet computer 1 includes, as shown in FIG. 2, a touch screen display 17, a CPU 101, a system controller 102, a main memory 103, a graphics controller 104, a BIOS-ROM 105, a non-volatile memory 106, a wireless LAN module 107, an embedded controller (EC) 108, and a 3G module 109.

The CPU 101 is a processor to control operation of each component in the tablet computer 1. The CPU 101 executes various kinds of software loaded from the non-volatile memory 106 that is a storage device into the main memory 103. The software include an operating system (OS) 103A and various application programs. The application programs include a browser application program 103B. The browser application program 103B has a display control function to control display of merchandise information. The display control function may be implemented by processing circuitry. Example of the processing circuitry includes a programmed processor, as the CPU 101. Example of the processing circuitry also includes ASIC and one or more electronic circuits arranged to perform the display control function.

The CPU 101 executes a basic input/output system (BIOS) stored in the BIOS-ROM 105. The BIOS is a program for hardware control.

The system controller 102 is a device to connect between a local bus of the CPU 101 and various components. The system controller 102 includes a memory controller which access-controls the main memory 103. Furthermore, the system controller 102 has a communication function to establish communication with the graphics controller 104 via a serial bus conforming to the PCI EXPRESS standard.

The graphics controller 104 is a display controller to control an LCD 17A used as a display monitor of the tablet computer 1. A display signal generated by the graphics controller 104 is transmitted to the LCD 17A. The LCD 17A displays a screen image based on the display signal. On the LCD 17A, a touch panel 17B and a digitizer 17C are disposed. The touch panel 17B is a capacitive pointing device that receives an input on the screen of the LCD 17A. A contact position of a finger on the screen and movement of the contact position on the screen are detected by the touch panel 17B. The digitizer 17C is an electromagnetic induction pointing device that receives an input on the screen of the LCD 17A. A contact position of a stylus on the screen, movement of the contact position, and contacting pressure are detected by the digitizer 17C.

The 3G module 109 is a device configured to execute 3G wireless mobile communication. The 3G module 109 establishes a wireless connection with, for example, the server 2. The tablet computer 1 receives merchandise information in accordance with the user's operation through the 3G module 109.

The wireless LAN module 107 is a device configured to perform communication based on IEEE 802.11n and Wi-Fi Direct. The wireless LAN module 107 can establish wireless connection between devices without any access point.

As a technique using Wi-Fi Direct, a technique which provides seamless display of content between wirelessly connected devices (Wi-Fi Display) is available. This technique realizes displaying the content on a screen of a sink device when the content view is requested in a source device, and thus, a user can view the content, which is displayed on a small screen of a device such as a smartphone and tablet computer (source device), on a larger screen of a television receiver (sink device) or the like.

The wireless LAN module 107 establishes wireless communication with, for example, the television receiver 3. The tablet computer 1 controls the television receiver 3 to display images of merchandise on the screen thereof through the wireless LAN module 107.

The EC 108 is a one-chip microcomputer which includes an embedded controller for power control. The EC 108 has a function to power the tablet computer 1 on or off according to power button operations by the user.

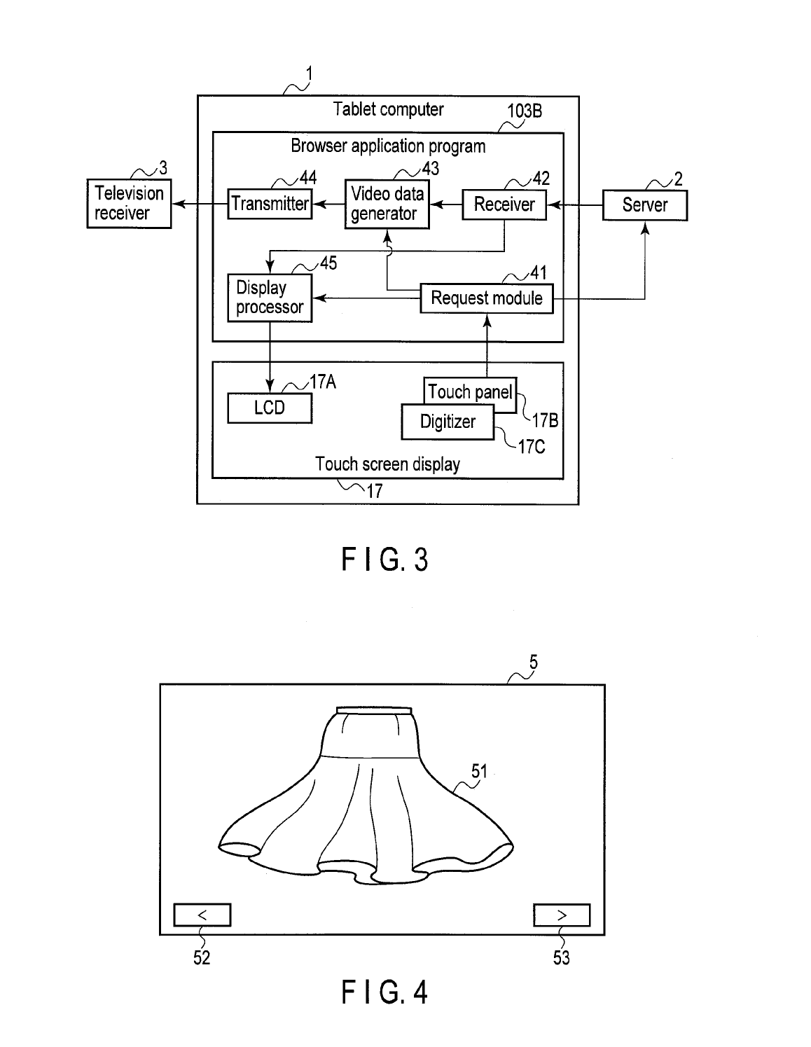

FIG. 3 shows a functional configuration of the browser application program 103B. As mentioned above, the browser application program 103B has a function to control the display of merchandise information. The browser application program 103B receives the merchandise information from the server 2, displays the images of merchandise on the screen of the television receiver 3, and displays the GUI elements for operations to buy an item on the screen of the LCD 17A. The browser application program 103B includes a request module 41, a receiver 42, a video data generator 43, a transmitter 44, and a display processor 45.

The request module 41 detects a request for display item information of a first item. The request module 41 receives events such as “touch”, “move (slide)”, and “release” occurring on the touch screen display 17, and from such events, detects that, for example, a button which is for requesting the display of item information of the first item and is displayed on the screen of the LCD 17A, is depressed.

In response to the request for display of the item information of the first item, the request module 41 detects resolution (size) of the screen of the television receiver 3. The information about the screen resolution of the television receiver 3 is received at the request module 41 when, for example, the wireless connection between the tablet computer 1 (wireless LAN module 107) and the television receiver 3 is established. The request module 41 transmits the request for the item information of the first item including the screen resolution of the television receiver 3 to the server 2. Note that the request module 41 transmits the request for the item information of the first item including the screen resolution of the television receiver 3 to the server 2 through, for example, the 3G module 109.

The server 2 provides online shopping services, that is, the server 2 provides the tablet computer 1 which is a client device with web content related to merchandise, and executes a process to buy an item through the web content. The web content includes the image and descriptive text of the item, menus and buttons used to buy the item, etc.

More specifically, according to the request from the request module 41, the server 2 generates, for example, image data of the first item (data for the television receiver 3) in accordance with the resolution of the screen of the television receiver 3 and GUI data (data for the tablet computer 1) for operations relating to the first item, and transmits the generated data to the tablet computer 1. To each data, the server 2 adds display screen specifying information which indicates whether the image data is used on television receiver 3 or on tablet computer 1. Using this information, the tablet computer 1 can determine whether the data is for the television receiver 3 or the tablet computer 1.

The data for the television receiver 3 includes image data (or movie data) of the first item. The data for the tablet computer 1 includes the data of GUI elements such as buttons and input areas for operations relating to the first item, and may be provided in, for example, HTML format for defining the layout of GUI elements on the screen. The operations relating to the first item include operations relating to viewing the image of the first item (operations such as rotation, enlargement/reduction, and color change) and operations for buying the first item. Note that the data for the television receiver 3 may include data of layout of the image (images) of the first item on the screen.

Here, the request module 41 may transmit the request for the item information of the first item including the screen resolution of the television receiver 3 and the screen resolution (size) of the LCD 17A to the server 2. In that case, the server 2 generates the image data of the first item in accordance with the screen resolution of the television receiver 3 and the GUI data for operations relating to the first item in accordance with the screen resolution of the LCD 17A, and transmits the generated data to the tablet computer 1.

The receiver 42 receives the data for the television receiver 3 (first data) and the data for the tablet computer 1 (second data) those correspond to the item information of the first item from the server 2 through, for example, the 3G module 109. By using the display screen specifying information included in each data, the receiver 42 outputs the data for the television receiver 3 to the video data generator 43 and outputs the data for the tablet computer 1 to the display processor 45.

The video data generator 43 generates video data to display the image of the first item on the screen of the television receiver 3 by using the data for the television receiver 3. The generated video data is, for example, video data in a codec (format) decodable by the television receiver 3.

The transmitter 44 transmits the generated video data to the television receiver 3 through, for example, the wireless LAN module 107. The transmitter 44 transmits the video data to the television receiver 3 using, for example, an MPEG-2 transport stream (MPEG-2 TS) container.

The television receiver 3 receives the video data transmitted from the transmitter 44. Then, the television receiver 3 displays the image of the first item on the screen thereof by using the video data.

As shown in FIG. 4, the television receiver 3 shows an image 51 of the first item on a screen 5. Note that images 52 and 53 which indicate that data of a plurality of items are sequentially displayable may be displayed on the screen 5 of the television receiver 3.

The display processor 45 displays the GUI elements for operations relating to the first item on the screen of the tablet computer 1 (that is, on the screen of the LCD 17A) by using the data for the tablet computer 1.

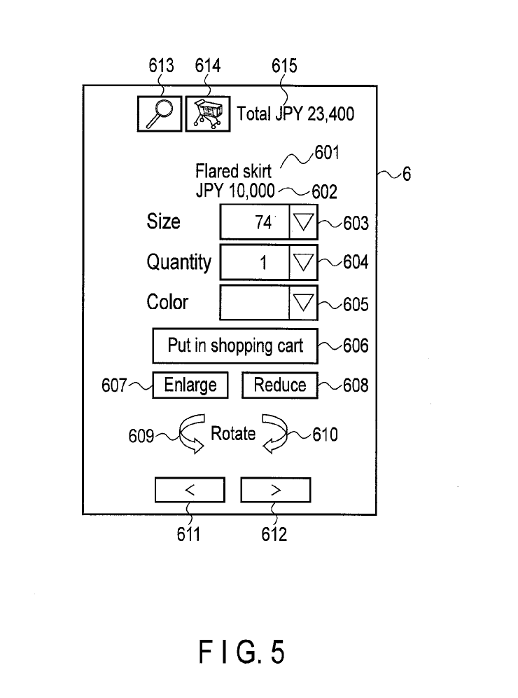

As shown in FIG. 5, on a screen 6 of the LCD 17A, the GUI elements for operations relating to the first item are displayed. More specifically, the screen 6 of the LCD 17A include, for example, a name area 601, a price area 602, a size button 603, a quantity button 604, a color button 605, an in-cart button 606, an enlargement button 607, a reduction button 608, rotation buttons 609 and 610, item change buttons 611 and 612, a search button 613, a cart button 614, and a price total area 615.

The name area 601 is an area to denote the name of item. The price area 602 is an area to denote the price of item. The size button 603 is a button for selecting the size of item to be bought. The quantity button 604 is a button for selecting the quantity of item to be bought. The color button 605 is a button for selecting the color of item to be bought. The in-cart button 606 is a button for putting the item in an online shopping cart. The enlargement button 607 is a button for displaying the enlarged image of the item. The reduction button 608 is a button for displaying the reduced image of the item. The rotation buttons 609 and 610 are buttons for displaying the rotated images of the item. The item change buttons 611 and 612 are buttons for displaying item information of other items. The search button 613 is a button for displaying a search screen for searching for an item. The cart button 614 is a button for displaying items currently in the online shopping cart. The price total area 615 is an area to denote a total sum payable for items currently in the online shopping cart.

By viewing the screen 5 of the television receiver 3 and the screen 6 of the LCD 17A, the user can refer to the image 51 of the first item on the large screen of the television receiver 3 and easily operate the buttons 603 to 614 for operations relating to the first item on the touch screen display 17 of the tablet computer 1.

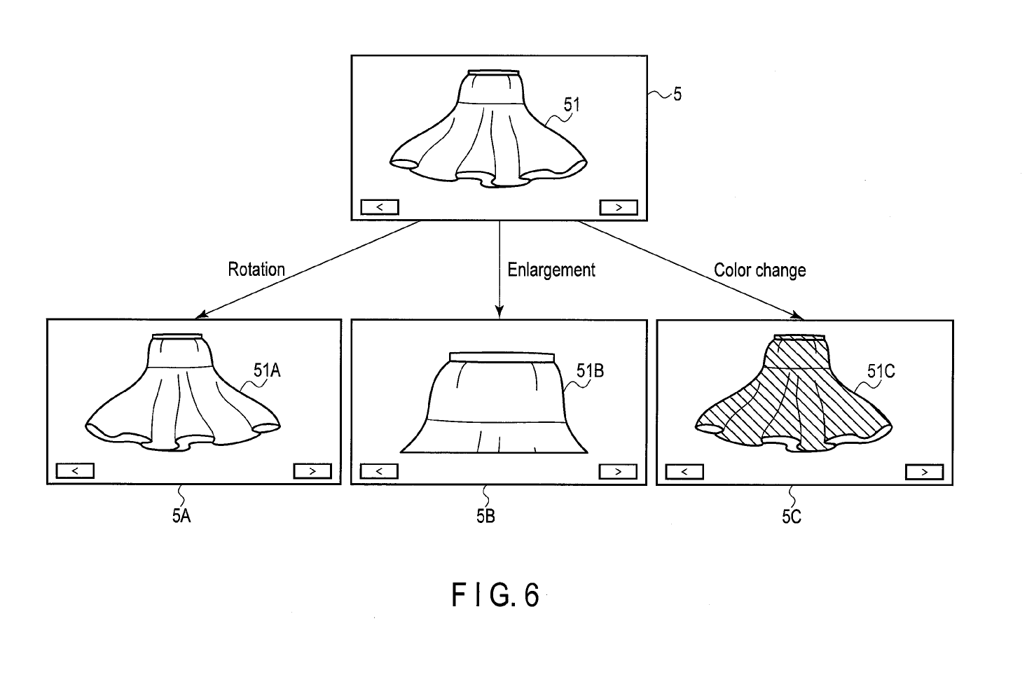

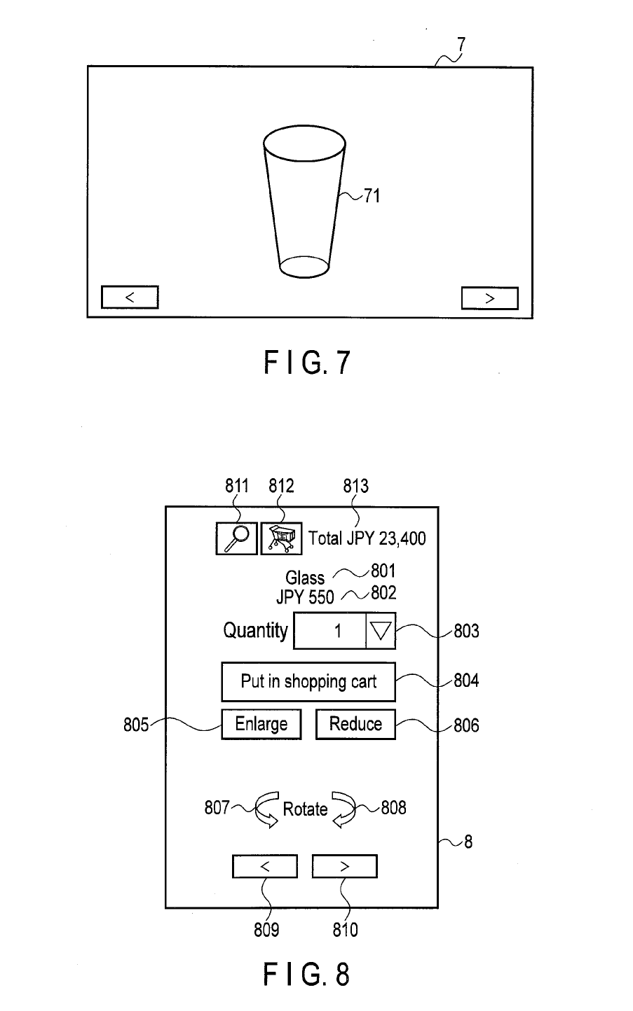

Now, with reference to FIGS. 6 and 7, an example of changing an image of an item currently being displayed on television receiver 3 in response to operations of the buttons 603 to 614 displayed on screen 6 of the LCD 17A will be described. Here, the description is presented given that the buttons on the screen 6 of the LCD 17A are operated while the image 51 of the first item is being displayed on the screen 5 of the television receiver 3.

FIG. 6 shows examples of images when the rotation button 609 or 610, enlargement button 607, and color button 605 on the screen 6 of the LCD 17A are pressed, respectively.

When the request module 41 receives operation information indicative of the rotation button 609 or 610 pressed, the request module 41 requests the video data generator 43 to generate video data to display the image of the item rotated by a predetermined angle in a designated rotation direction (the direction corresponding to the rotation button 609 or 610 currently being pressed).

In response to the request by the request module 41, the video data generator 43 generates the video data to display the image of the rotated item by using the item information received from the server 2. The item information includes a plurality of images viewed from different angles, for example. The video data generator 43 generates the video data using the image whose rotation angle corresponds to the operation of the rotation button 609 or 610 in the item information.

Note that the item information may include three dimensional model data of the item. In that case, the video data generator 43 generates an image whose rotation angle corresponds to the operation of the rotation button 609 or 610 by using the three dimensional model data of the item, and generates the video data by using the generated image.

When the request module 41 receives operation information indicating that the enlargement button 607 is pressed, the request module 41 requests the video data generator 43 to generate video data to display the image of the item enlarged to a predetermined magnification.

In response to the request by the request module 41, the video data generator 43 generates the video data to display the enlarged image of the item by using the item information from the server 2. The video data generator 43 enlarges the item image in the item information from the server 2 and generates the video data using the enlarged image.

In the same manner, when the reduction button 608 is pressed, the request module 41 and the video data generator 43 generate the video data to display the image of the item reduced to a predetermined magnification.

Furthermore, when the request module 41 receives operation information indicative of a color changed by using the color button 605, the request module 41 requests the video data generator 43 to generate video data to display the image of the item in the changed color.

In response to the request by the request module 41, the video data generator 43 generates the video data to display the image of the item in the changed color by using the item information from the server 2. The item information includes, for example, a plurality of images in different colors of a certain item. From the item information, the video data generator 43 generates the video data by using the image of the item corresponding to the color changed by using the operation of the color button 605.

Note that the item information may include an image of an item in only one color. In that case, the video data generator 43 executes image processing to convert the image of the item into an image of the item in the color designated by the operation of the color button 605, and generates video data by using the image of the item whose color has been converted.

FIGS. 7 and 8 show an example of a screen of the television receiver 3 and an example of a screen of the tablet computer 1 (LCD 17A), respectively, at a time when the item change button 611 or 612 is pressed. In response to the press of the item change button 611 or 612, the television receiver 3 changes the screen 5 on which the image 51 of the first item is displayed into, as shown in FIG. 7, screen 7 on which an image 71 of a second item is displayed. Also, in response to the press of the item change button 611 or 612, the tablet computer 1 changes the screen 6 displaying GUI elements 601 to 615 for operations relating to the first item to, as shown in FIG. 8, screen 8 displaying GUI elements 801 to 813 for operations relating to the second item.

More specifically, when the request module 41 receives operation information indicative that the item change button 611 or 612 has been pressed, the request module 41 requests the server 2 to transmit item information of an item (second item) corresponding to the pressed button 611 or 612. The server 2 transmits the item information of the second item requested by the request module 41 to the tablet computer 1. The receiver 42 receives the item information of the second item from the server 2 and outputs the item information to the video data generator 43 and the display processor 45.

The video data generator 43 generates video data to display an image 71 of the second item on the screen of the television receiver 3 by using the item information of the second item. The transmitter 44 transmits the generated video data to the television receiver 3. Thus, on the screen of the television receiver 3, the screen image 7 including the image 71 of the second item is displayed.

Furthermore, the display processor 45 displays GUI elements 801 to 813 for operations relating to the second item on the screen of the tablet computer 1 (LCD 17A) by using the item information of the second item.

The GUI elements 601 to 615 for operations relating to the first item shown in FIG. 5 and the GUI elements 801 to 813 for operations relating to the second item shown in FIG. 8 may be different from each other in respect of objects (buttons). This is because each item has its suitable GUI elements. In the example shown in FIG. 5, for the first item as a flared skirt, the GUI elements include the size button 603 for selecting the size of skirt and the color button 605 for selecting the color of skirt. On the other hand, in the example shown in FIG. 8, for the second item as a glass, there is no button for selecting size or color. In such a manner, the browser application program 103B can provide GUI elements suitable for each item on the screen of the LCD 17A.

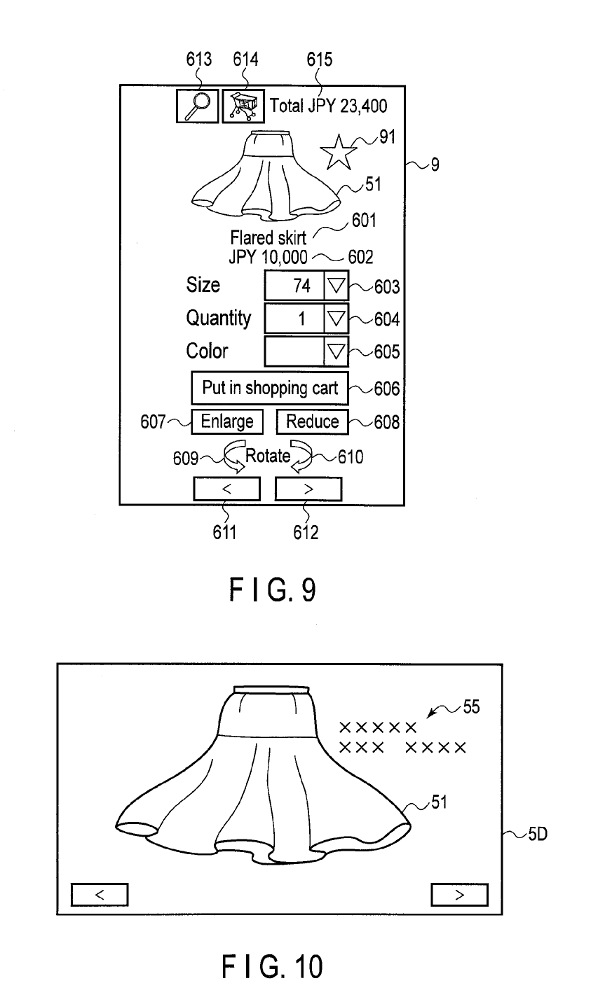

Furthermore, as shown in FIG. 9, on a screen 9 of the tablet computer 1 (LCD 17A), an image of an item and GUI elements for operations relating to the item may be displayed. The image 51 of the item as shown in FIG. 4 and GUI elements (buttons and the like) 601 to 615 for operations relating to the item as shown in FIG. 5 are displayed in combination on the screen 9. By using the screen 9, the user checks the image 51 of the item on the screen 9 and performs operations relating to the item.

However, as mentioned above, in such a small screen as the screen 9, the image size is small and details of the item may not be checked from the image 51. Furthermore, the size of the GUI element such as a button is also small and the user may touch an irrelevant button unintentionally.

Therefore, the screen 9 further includes an external display button 91 which indicates that the image 51 of the item therein is displayable in an external display. If the external display button 91 is pressed, the request module 41 requests the video data generator 43 to generate video data to display the image 51 of the item on the screen of the television receiver 3 and requests the display processor 45 to display GUI elements for operations relating to the item on the screen of the LCD 17A. Thus, the image 51 of the item is shown on the screen of the television receiver 3 as shown in FIG. 4, and GUI elements 601 to 615 are shown in the screen of the tablet computer 1 (LCD 17A) as shown in FIG. 5. That is, by the user operation, the user can select either displaying the image 51 and GUI elements 601 to 615 of the item on a single screen or displaying the image 51 of the item on one of two screens and GUI elements 601 to 615 on the other screen.

Furthermore, on the screen of the LCD 17A in the touch screen display 17, an area to receive handwriting input operations can be provided in addition to GUI elements 601 to 615 as shown in FIG. 5. The user handwrites characters and figures on the area to set a handwritten note relating to an item.

As shown in FIG. 10, handwritten characters and FIG. 55 may be displayed on the screen of the television receiver 3. The video data generator 43 generates video data to display the image 51 of the item and handwritten information 55 on the screen of the television receiver 3 in response to the handwriting input operation using the touch screen display 17. The transmitter 44 transmits the generated video data to the television receiver 3. Thus, the image 51 of the item and the handwritten information 55 are displayed on the screen of the television receiver 3.

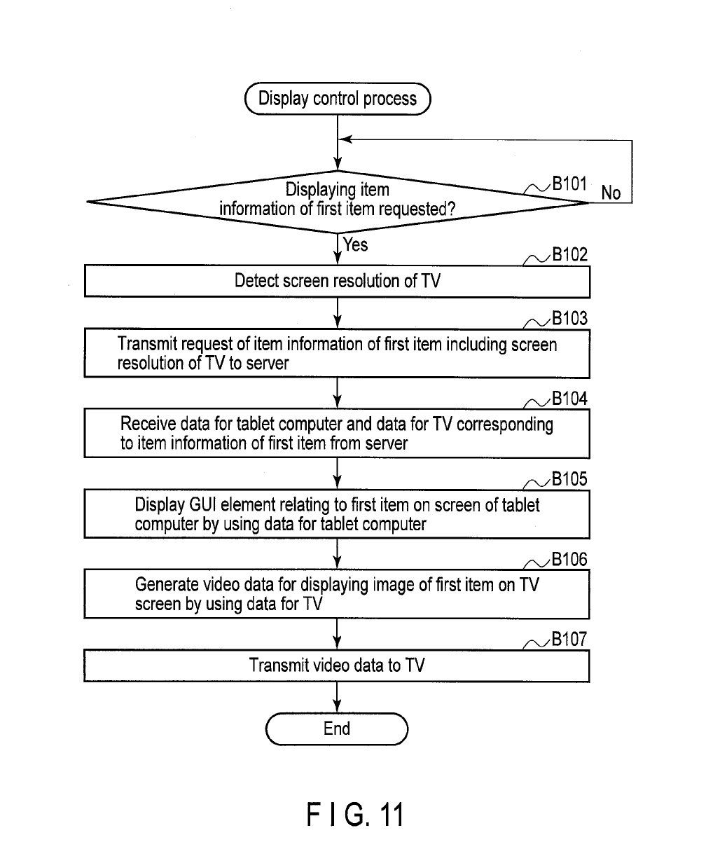

Now, an example of the procedure of display control process executed by the tablet computer 1 is described with reference to a flowchart in FIG. 11.

Initially, the request module 41 determines whether display of item information of a first item is requested (block B101). If the display is not requested (No in block B101), the procedure returns to block B101 and whether the display of item information is requested is determined again.

If the display is requested (Yes in block B101), the request module 41 detects resolution (size) of a screen of the television receiver 3 (block B102). The request module 41 transmits a request for the item information of the first item including the resolution of the screen of the television receiver 3 to the server 2 (block B103). In response to this request, the server 2 generates, for example, image data of the first item in accordance with the resolution of the screen of the television receiver 3 (data for the television receiver 3) and GUI data for operations relating to the first item (data for the tablet computer 1), and transmits the generated data to the tablet computer 1.

The receiver 42 receives the data for the television receiver 3 and the data for the tablet computer 1 which correspond to the item information of the first item from the server 2 (block B104). The data for the television receiver 3 includes image data of the first item. The data for the tablet computer 1 includes the GUI data for operations relating to the first item and are provided in, for example, HTML format. The display processor 45 display GUI elements for operations relating to the first item on the screen of the tablet computer 1 (that is, the screen of the LCD 17A) by using the data for the tablet computer 1 (block B105).

Furthermore, the video data generator 43 generates video data to display the image of the first item on the screen of the television receiver 3 by using the data for the television receiver 3 (block B106). Then, the transmitter 44 transmits the generated video data to the television receiver 3 (block B107).

The television receiver 3 displays the image of the first item on its screen using the video data. Therefore, a user can refer to the image of the first item on a large screen of the television receiver 3 and operate the GUI elements for operations relating to the first item on the touch screen display 17 of the tablet computer 1.

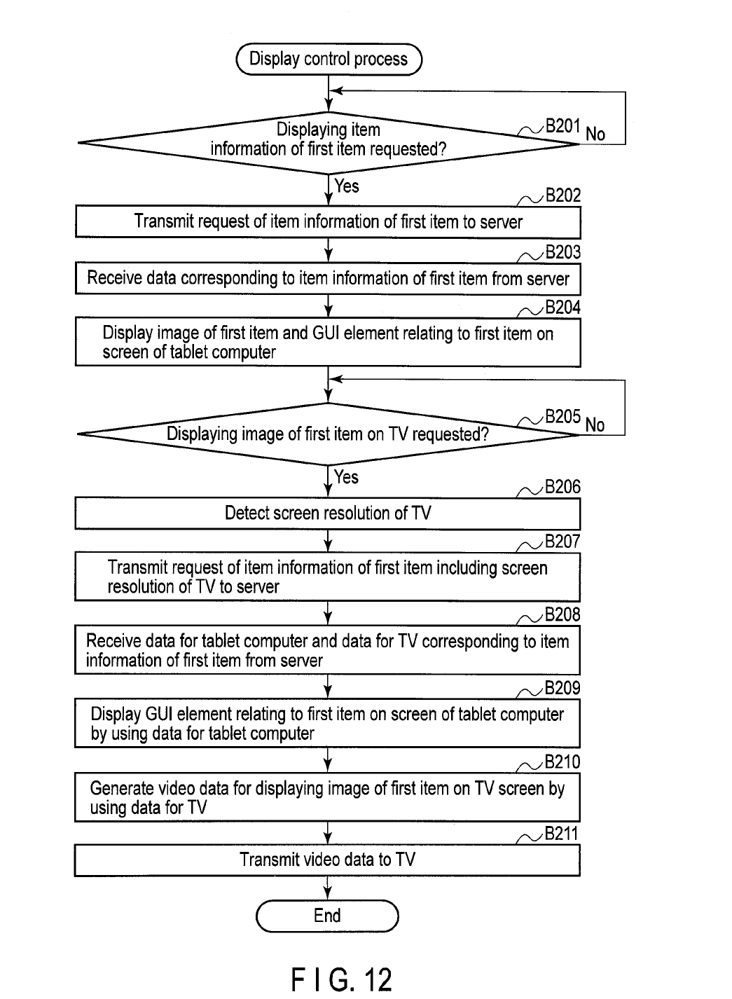

Now, another example of the procedure of display control process executed by the tablet computer 1 is described with reference to a flowchart in FIG. 12.

Initially, the request module 41 determines whether display of item information of a first item is requested (block B201). If the display is not requested (No in block B201), the procedure returns to block B201 and whether the display of item information is requested is determined again.

If the display is requested (Yes in block B201), the request module 41 transmits a request for the item information of the first item to the server 2 (block B202). In response to this request, the server 2 generates, for example, image data of the first item and GUI data for operations relating to the first item, and transmits the generated data to the tablet computer 1.

The receiver 42 receives the data corresponding to the item information of the first item from the server 2 (block B203). The data includes both the image data of the first item and the GUI data for operations relating to the first item, and are provided in, for example, HTML format. The display processor 45 displays the image of the first item and GUI elements for operations relating to the first item on the screen of the tablet computer 1 (that is, the screen of the LCD 17A) by using the data (block B204).

Then, the request module 41 determines whether the image of the first item displayed on the screen of the tablet computer 1 is requested to be displayed on the screen of the television receiver 3 (block B205). The request module 41 receives events such as “touch”, “move (slide)”, and “release” occurring on the touch screen display 17, and based thereon, determines whether the button on the screen of the LCD 17A to request the image of the first item to be displayed on the screen of the television receiver 3 is pressed. If the image of the first item is not requested to be displayed on the screen of the television receiver 3 (No in block B205), the procedure returns to block B205 and whether the image of the first item is requested to be displayed on the screen of the television receiver 3 is determined again.

If the image of the first item is requested to be displayed on the screen of the television receiver 3 (Yes in block B205), the request module 41 detects the resolution (size) of the screen of the television receiver 3 (block B206). The request module 41 transmits the request for the item information of the first item including the resolution of the screen of the television receiver 3 to the server 2 (block B207). In response to this request, the server 2 generates, for example, the image data of the first item in accordance with the resolution of the screen of the television receiver 3 (data for the television receiver 3) and the GUI data for operations relating to the first item (data for the tablet computer 1), and transmits the data to the tablet computer 1.

The receiver 42 receives the data for the television receiver 3 (first data) and data for the tablet computer 1 (second data) which correspond to the item information of the first item from the server 2 (block B208). The display processor 45 displays the GUI elements for operations relating to the first item on the screen of the tablet computer 1 (LCD 17A) by using the data for the tablet computer (block B209).

The video data generator 43 generates the video data for displaying the image of the first item on the screen of the television receiver 3 by using the data for the television receiver 3 to (block B210). Then, the transmitter 44 transmits the generated video data to the television receiver 3 (block B211).

The television receiver 3 displays the image of the first item on its screen by using the video data. Thus, when the user performs an operation to request for displaying the image of the first item on the screen of the television receiver 3, the user can refer to the image of the first item on the large screen of the television receiver 3 and operate the GUI elements for operation relating to the first item on the touch screen display 17 of the tablet computer 1.

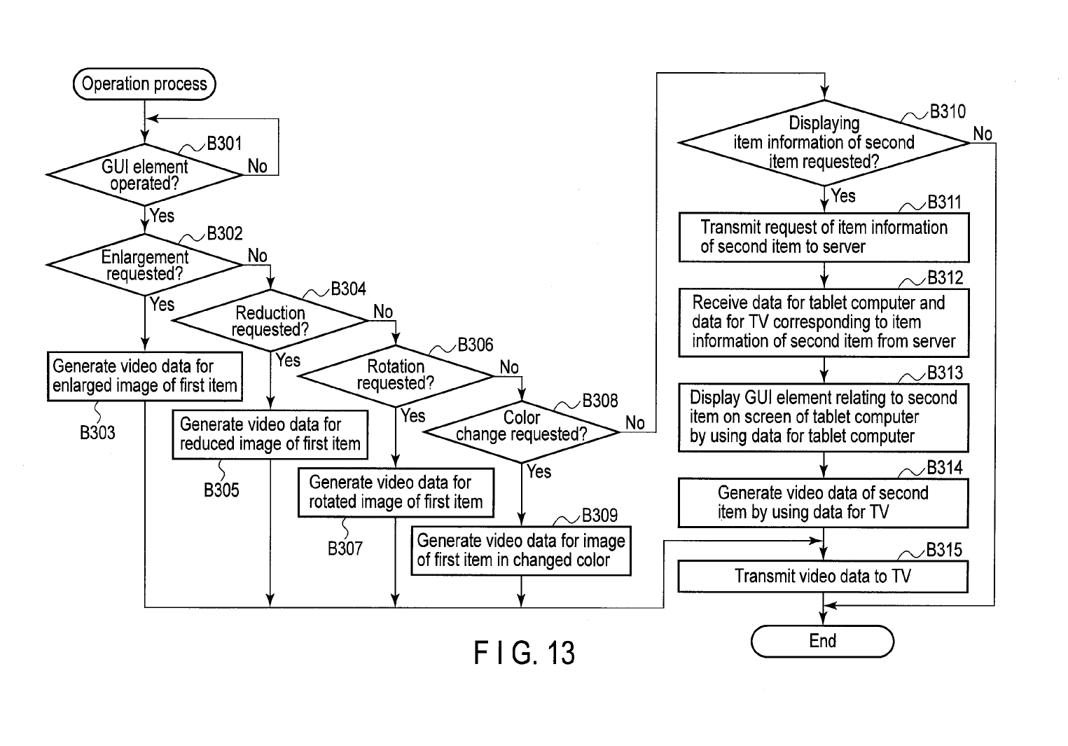

Now, another example of the procedure of display control process executed by the tablet computer 1 is described with reference to a flowchart in FIG. 13. Hereinafter, it is assumed that the image of the first item is displayed on the screen of the television receiver 3 and the GUI elements for operations relating to the first item are displayed on the screen of the tablet computer 1.

Initially, the request module 41 determines whether the GUI elements for operations relating to the first item are operated (block B301). The request module 41 receives events such as “touch”, “move (slide)”, and “release” occurring on the touch screen display 17, and based thereon, determines whether, for example, the GUI elements (buttons, menus, etc.) for operations relating to the first item displayed on the screen of the LCD 17A are operated. If there is no operation on a GUI element (No in block B301), the procedure returns to block B301 to again determine whether there is an operation on a GUI element.

If there is an operation on a GUI element (Yes in block B301), the request module 41 executes a process corresponding to the operation. More specifically, the request module 41 determines whether there is a request for enlargement of the image of the first item (block B302). If the image of the first item is requested to be enlarged (Yes in block B302), that is, if the enlargement button 607 on the screen of the LCD 17A is pressed, the video data generator 43 generates video data for displaying the enlarged image of the first item on the screen of the television receiver 3 (block B303), and the transmitter 44 transmits the video data to the television receiver 3 (block B315).

If the enlargement of the image of the first item is not requested (No in block B302), the request module 41 determines whether there is a request for reduction of the image of the first item (block B304). If the image of the first item is requested to be reduced (Yes in block B304), that is, if the reduction button 608 on the screen of the LCD 17A is pressed, the video data generator 43 generates video data for displaying the reduced image of the first item on the screen of the television receiver 3 (block B305), and the transmitter 44 transmits the video data to the television receiver 3 (block B315).

If the reduction of the image of the first item is not requested (No in block B304), the request module 41 determines whether there is a request for rotation of the image of the first item (block B306). If the image of the first item is requested to be rotated (Yes in block B306), that is, if the rotation button 609 or 610 on the screen of the LCD 17A is pressed, the video data generator 43 generates video data for displaying the rotated image of the first item on the screen of the television receiver 3 (block B307), and the transmitter 44 transmits the video data to the television receiver 3 (block B315).

If the rotation of the image of the first item is not requested (No in block B306), the request module 41 determines whether there is a request for changing color of the image of the first item (block B308). If the image of the first item is requested in a different color (Yes in block B308), that is, if the color button 605 on the screen of the LCD 17A is pressed, the video data generator 43 generates video data for displaying the image of the first item in the different color on the screen of the television receiver 3 (block B309), and the transmitter 44 transmits the video data to the television receiver 3 (block B315).

If the color change of the image of the first item is not requested (No in block B308), the request module 41 determines whether there is a request for displaying item information of the second item (block B310). If the image of the second item is requested to be displayed (Yes in block B310), that is, if the item change button 611 or 612 on the screen of the LCD 17A is pressed, the request module 41 requests the server 2 to send item information of the second item including the resolution of the screen of the television receiver 3 (block B311). In response to this request, the server 2 generates, for example, the video data of the second item in accordance with the resolution of the screen of the television receiver 3 (data for the television receiver 3) and the GUI data for operations relating to the second item (data for the tablet computer 1), and transmits the data to the tablet computer 1.

The receiver 42 receives from the server 2 the data for the television receiver 3 and the data for the tablet computer 1 which correspond to the item information of the second item (block B312). The data for the television receiver 3 includes image data of the second item. The data for the tablet computer 1 includes the GUI data for operations relating to the second item and are provided in, for example, HTML format. The display processor 45 displays the GUI elements for operations relating to the second item on the screen of the tablet computer 1 by using the data for the tablet computer 1 (block B313).

Furthermore, the video data generator 43 generates video data for displaying the image of the second item on the screen of the television receiver 3 by using the data for the television receiver 3 (block B314). Then, the transmitter 44 transmits the generated video data to the television receiver 3 (block B315). Thus, based on this video data, the image of the second item is displayed on the screen of the television receiver 3.

As described above, the present embodiment provides easy operation of GUI in content. The receiver 42 receives first data for displaying an image of the first item (data for the television receiver 3) and second data for displaying a graphical user interface relating to the first item (data for the tablet computer 1) from the server 2. The display processor 45 displays the graphical user interface on the screen of the LCD 17A by using the second data. The video data generator 43 generates first video data to display an image on the television receiver 3 (external display) by using the first data. The transmitter 44 transmits the first video data to the television receiver 3. Thus, the image of first item using the first video data is displayed on the screen of the television receiver 3 and the GUI elements are displayed on the screen of the LCD 17A. Therefore, the content of the item is displayed clearly and the user can easily operate the GUI elements on the screen of the LCD 17A.

All the procedures in the present embodiment, which have been described with reference to flowcharts of FIGS. 11 to 13, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

Each of the functions of the embodiments may be implemented by processing circuitry.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver to receive first data and second data from a server, the first data for displaying an image of a first item, the second data for displaying a graphical user interface relating to the first item;
processing circuitry to display the graphical user interface on a screen based on the second data, and to generate first video data for displaying the image of the first item on an external display based on the first data; and
a transmitter to transmit the first video data to the external display.

2. The electronic apparatus of claim 1, wherein the receiver receives third data and fourth data in accordance with a first operation using the graphical user interface, the third data for displaying an image of a second item, the fourth data for displaying a graphical user interface relating to the second item,
the processing circuitry displays the graphical user interface relating to the second item on the screen based on the fourth data, and to generate second video data for displaying the image of the second item on the external display based on the third data, and
the transmitter transmits the video data to the external display.

3. The electronic apparatus of claim 1, wherein the processing circuitry generates second video data in accordance with a first operation using the graphical user interface, the second video data for displaying an enlarged or reduced image of the first item, and
the transmitter transmits the second video data to the external display.

4. The electronic apparatus of claim 1, wherein the processing circuitry generates second video data in accordance with a first operation using the graphical user interface, the second video data for displaying a rotated image of the first item, and
the transmitter transmits the second video data to the external display.

5. The electronic apparatus of claim 1, wherein the processing circuitry generates second video data in accordance with a first operation using the graphical user interface, the second data for displaying the image of the first item in a different color, and
the transmitter transmits the second video data to the external display.

6. The electronic apparatus of claim 1, wherein the processing circuitry generates second video data in accordance with the first operation using the graphical user interface, the second video data for displaying the image of the first item and handwritten information associated with the first item, and
the transmitter transmits the second video data to the external display.

7. The electronic apparatus of claim 1, further comprising a touch screen display, wherein
the processing circuitry displays the graphical user interface on the touch screen display.

8. A display control method comprising:
receiving first data and second data from a server, the first data for displaying an image of a first item, the second data for displaying a graphical user interface relating to the first item;
displaying the graphical user interface on a screen based on the second data;
generating first video data for displaying the image of the first item on an external display based on the first data; and
transmitting the first video data to the external display.

9. A computer-readable, non-transitory storage medium having stored thereon a program which is executable by a computer, the program controlling the computer to execute functions of:
receiving first data and second data from a server, the first data for displaying an image of a first item, the second data for displaying a graphical user interface relating to the first item;
displaying the graphical user interface on a screen based on the second data;
generating first video data for displaying the image of the first item on an external display based on the first data; and
transmitting the first video data to the external display.
